(19) United States
(12) Patent Application Publication
(10) Pub. No.: US 2014/0158681 A1
(43) Pub. Date: Jun. 12, 2014

(54) FASTENING ASSEMBLY FOR MODULAR CONTAINER

(71) Applicant: TITAN ENERGY SERVICES LTD., Calgary (CA)

(72) Inventors: Kevin TAILLEFER, Calgary (CA); Brett ADAMS, Okotoks (CA)

(73) Assignee: Titan Energy Services Ltd., Calgary (CA)

(21) Appl. No.: 13/707,102

(22) Filed: Dec. 6, 2012

(51) Int. Cl. B65D 90/02; B65D 88/52; F16B 5/00

(52) U.S. Cl. CPC B65D 90/023; F16B 5/0084; B65D 88/528
USPC 220/4.16; 403/292; 220/4.33; 29/525.08

(57) ABSTRACT

Modular panels for forming a container have a plurality of securing receptacles on a first end of the panel and a plurality of securing receptacles on a second end of the panel. Each one of the securing receptacles on the first end of the panel is position at approximately the same height as a corresponding one of the securing receptacles on the second end of the panel. Each pair of corresponding securing receptacles is dimensioned to receive a securing bar therein that can be locked in place to hold adjacent panels in a secured position.

### TECHNICAL FIELD

The present invention relates to fastening systems for containers, and in particular to fastening systems for modular containers comprising a plurality of panels.

### BACKGROUND

Modular containers having a plurality of panels or segments that can be fastened together have a variety of uses. Some such containers can be of a significant size or volume. For example, some such containers are used to store fracturing fluids used and/or produced during hydraulic fracturing of oil or gas wells, drilling fluids produced when drilling an oil well or other type of well, temporary storage of potable water, storage of agricultural products, or storage of sand or other solids, or the like.

It is desirable to provide improved fastening systems for modular containers that facilitate the assembly and disassembly of such containers, while providing sufficient strength to ensure that the structure of the container is not compromised during use.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In one embodiment, a modular panel for use in forming a container is provided. A plurality of securing receptacles are on a first end of the panel and a plurality of securing receptacles are on a second end of the panel. Each one of the plurality of securing receptacles on the first end of the panel are positioned at approximately the same elevation relative to a base of the panel as a corresponding one of the securing receptacles on the second end of the panel to provide a pair of corresponding securing receptacles, and each pair of corresponding securing receptacles is dimensioned to receive a securing bar therein so that the securing bar can be retained within the securing receptacles to hold the panels in a secured position when two panels are engaged in abutting end-to-end relationship. In some embodiments, the securing bar is slideably received within the securing receptacles. In some embodiments, the securing bar has a locking mechanism at its first and second ends. In one embodiment, a panel assembly comprising two such modular panels are aligned in abutting end-to-end engagement, with the securing receptacles on the first end of a first one of the panels being positioned adjacent the securing receptacles on the second end of a second one of the panels, the panels being retained in the secured position by at least one securing bar locked within at least one pair of corresponding securing receptacles.

In one embodiment, a fastening system for securing two modular panels in abutting end-to-end relationship is provided. The fastening system has a plurality of pairs of corresponding securing receptacles, a first member of each pair of corresponding securing receptacles is provided on one end of a first one of the modular panels and a second member of each pair of corresponding securing receptacles is provided on one end of a second one of the modular panels at approximately the same elevation relative to a base of the panels as the first member of the pair of corresponding securing receptacles. The fastening system also has a plurality of securing bars. Each one of the securing bars is slideably engageable within one of the pairs of corresponding securing receptacles. Each one of the securing bars has a locking mechanism to prevent movement of the securing bar relative to the pair of corresponding securing receptacles when the panels are in a secured configuration.

In one embodiment, a method of assembling a container formed from two or more modular panels is provided. First and second modular panels are aligned in abutting end-to-end relationship, so that each one of a plurality of securing receptacles on one end of the first modular panel are aligned with a corresponding one of a plurality of securing receptacles on one end of the second modular panel to provide a pair of corresponding securing receptacles. A securing bar is inserted through at least two of the pairs of corresponding securing receptacles. The securing bar is locked against movement relative to the securing receptacles.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a side view of a panel according to one embodiment of the present invention.

FIG. 2 is a partial end view of the panel of FIG. 1 with the curved portion of the panel body omitted for clarity.

FIG. 3 is a partial side view showing two panels in the secured position according to an exemplary embodiment.

FIG. 4 is a top view of a securing bar according to an exemplary embodiment.

FIG. 5 is a side view of a locking pin according to an exemplary embodiment.

FIG. 6 is a partial top view showing two panels in the secured position according to an exemplary embodiment, with the securing bar omitted for clarity.

FIG. 7 is a perspective view of a container formed from a plurality of curved modular panels according to one embodiment.

FIG. 8 is a partial top view of two flat panels engaged in the secured position with an angled panel according to one embodiment.

FIG. 9 is a partial side view showing the relation of two panels after the securing bars have been placed in a travel position.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

For ease of reference herein, the term “vertical” is used to describe the relative location of features with reference to the orientation of the panels shown in the drawings and as such panels would typically be oriented during use. It will be appreciated that the subject matter described herein could have other orientations (for example, panels could be laid flat for shipping or storage), in which case one skilled in the art would appreciate that the relative orientation of the direction that has been described herein as “vertical” could in fact extend in some other direction, such as a horizontal direction, and that subject matter having such orientations falls within the scope of the appended claims.

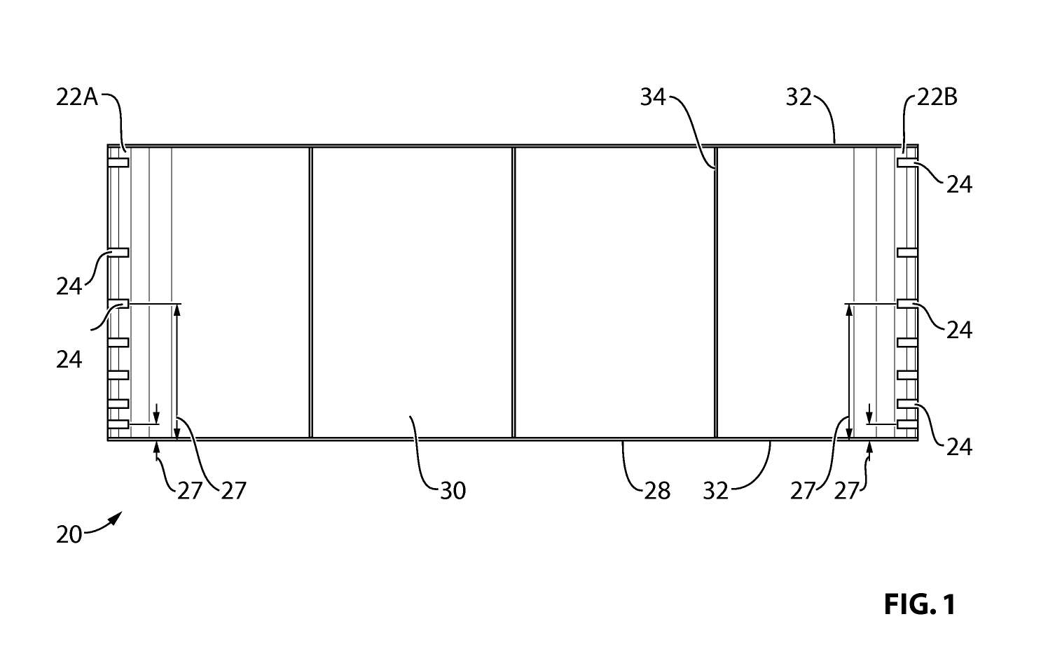

With reference to FIG. 1, an exemplary embodiment of a panel 20 for use in a modular tank assembly is illustrated. Panel 20 is generally rectangular in shape and has two opposed ends 22A, 22B having a plurality of securing receptacles 24 thereon. Panel 20 is curved along its length. Securing receptacles 24 are disposed at a plurality of different vertical elevations along the height of panel 20. Corresponding pairs of securing receptacles 24 are disposed at approximately the same vertical elevations along the height of panel 20 (relative to a base 28 of panel 20), and are oriented to receive a securing bar 26 (FIGS. 3 and 4), which holds panels 20 in a secured position when panels 20 are engaged in abutting end-to-end relationship. In some embodiments, each securing bar 26 is slidably received in a pair of corresponding securing receptacles 24.

In some embodiments, panel 20 could have shapes other than rectangular, for example, generally square. In some embodiments, panel 20 can be constructed from a plurality of panel segments that have been welded or otherwise secured together in any suitable manner to provide a panel 20 of a size larger than the individual panel segments. It will be apparent that the shape of panel 20 need not be strictly square or rectangular; for example, the ends of panel 20 could be somewhat angled or otherwise not straight without interfering with the function of panel 20, provided that panels 20 are correspondingly shaped at each end 22A, 22B so that two panels are engageable in abutting end-to-end relationship. In some embodiments, panel 20 can be constructed from a plurality of panel segments having different thicknesses that have been welded or otherwise secured together in any suitable manner. For example, in some embodiments, the upper portion of panel 20 is made from a plurality of panel segments that are thinner than the panel segments used to make the lower portion of panel 20.

Panel 20 has a lower edge, illustrated as base 28. Each one of securing receptacles 24 on first end 22A of panel 20 is positioned at approximately the same vertical elevation 27 above base 28 as a corresponding one of the securing receptacles 24 on second female end 22B of panel 20 to provide a pair of corresponding securing receptacles 24. Each pair of corresponding securing receptacles 24 are positioned and dimensioned to receive a securing bar 26 therethrough, to secure panels 20 together when panels 20 are engaged in abutting end-to-end relationship.

The securing receptacles 24 are dimensioned to be engageable with the securing bar 26 when a corresponding pair of panels 20 are aligned in abutting end-to-end relationship. For example, in the illustrated embodiment, the securing receptacles 24 are slideably engageable with securing bar 26. Securing receptacles 24 are generally square in cross-section, and the securing bar 26 is generally square in cross-section, such that securing bar 26 can be slidably inserted through a pair of corresponding securing receptacles 24 when panels 20 are aligned in abutting end-to-end relationship to hold the adjacent panels 20 in a secured position (i.e. securing bar 26 is slidably engageable with a pair of corresponding securing receptacles 24). In other embodiments, the securing receptacles and securing bar could independently be rectangular, circular, pentagonal, hexagonal or the like, or asymmetrical in cross-section, and could have the same or different cross-sectional shapes, so long as the securing bar can be inserted through a corresponding pair of securing receptacles on adjacent panels to hold panels 20 in the secured position.

In the illustrated embodiment, securing receptacles 24 have been illustrated as being spaced at different vertical elevations along the height of panel 20, so that a larger number of pairs of corresponding securing receptacles 24 are positioned on the lower half of panel 20 than on the upper half of panel 20. In alternative embodiments, the elevations of corresponding pairs of securing receptacles 24 can be varied or made more or less even along the height of panel 20. In some embodiments, securing receptacles 24 are spaced apart at approximately equal vertical elevations along the height of panel 20. Any number and location of securing receptacles 24 may be used, as may be appropriate for any particular application. In the illustrated embodiment, five pairs of corresponding securing receptacles 24 are provided on the lower half of panel 20, and two pairs of corresponding securing receptacles 24 are provided on the upper half of panel 20. In another exemplary embodiment, six corresponding pairs of securing receptacles 24 are provided, and are spaced roughly equally apart across the height of panel 20. Other arrangements and numbers of securing receptacles 24 may be used.

Panel 20 is formed from a panel body 30. To reinforce the structure of panel body 30, in the illustrated embodiment top and bottom support members 32 are provided. One or more spaced apart reinforcing ribs 34 are provided that extend vertically along the height of panel body 30 to provide added strength. In some embodiments, reinforcing ribs 34 are omitted. In some embodiments, top and/or bottom support members 32 are omitted. In some embodiments, reinforcing ribs 34 and top and/or bottom support members 32 are omitted.

Suitable materials for the manufacture of all components of panels 20, including top and bottom support members 32 and reinforcing ribs 34, include carbon steel, stainless steel, corrugated steel, aluminum, composite, fibreglass-reinforced plastic (FRP), or the like. Different components of panel 20 could independently be made from different materials. The selection of suitable materials depending on the desired application (e.g. nature and volume of the material to be contained, environmental conditions under which the panels will be used, and the like) and manufacture of the components described herein is within the skill of one knowledgeable in the art. For example, securing receptacles 24 can be machined separately from the panel body 30 and then welded on to panel body 30, or otherwise integrally formed with or joined to panel body 30 in any suitable manner. In some embodiments, securing receptacles 24 are formed from hollow structural sections of steel. In some embodiments, securing receptacles 24 are formed from steel cast into an appropriate shape.

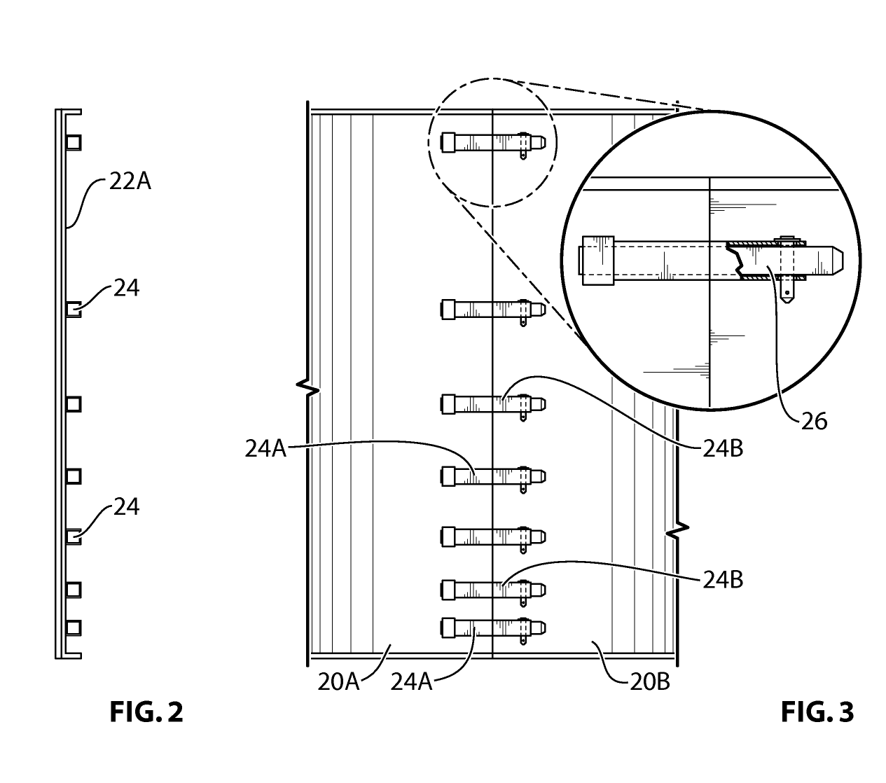

FIG. 2 shows a partial end view of the panel of FIG. 1 with the curved portion of the panel body omitted for clarity. In the illustrated embodiment, securing receptacles 24 project outwardly from panel body 30.

FIG. 3 shows a partial view of two panels 20A and 20B connected by engagement of securing bars 26 between corresponding pairs of securing receptacles 24A of first panel 20A and securing receptacles 24B of second panel 20B. To connect panels 20A and 20B, the panels are aligned in abutting end-to-end relationship. A securing bar 26 is inserted through a pair of corresponding securing receptacles 24A and 24B of first and second panels 20A and 20B.

In the illustrated embodiment, as best shown in FIG. 4, securing bars 26 are formed from an elongate piece of a suitable material having a generally square cross-section, and are slideably received in securing receptacles 24. Each one of the securing bars 26 has locking mechanisms at its first and second ends 26A, 26B so that the securing bar 26 can be used to hold a corresponding pair of securing receptacles 24A, 24B in the secured position. The locking mechanisms prevent relative motion of securing receptacles 24 and securing bars 26 when the panels 20 are in the secured position.

In the illustrated embodiment, a cap end 36 at a first end 26A of the securing bar 26 provides one of the locking mechanisms. In the illustrated embodiment, cap end 36 is an outwardly extending projection having a diameter larger than the diameter of securing bar 26, and sufficiently large that cap end 36 cannot pass through securing receptacles 24. In some embodiments, cap end 36 is formed from a hollow structural section having a slightly larger diameter than securing bar 26. In some embodiments, cap end 36 is integrally formed with securing bar 26, which is cast in a mold. Cap end 36 can be formed in any desired shape. Cap end 36 prevents first end 26A of securing bar 26 from being passed through one of the securing receptacles 24. Cap end 36 may be manufactured in any suitable manner, and joined, welded, integrally formed with or in any suitable manner secured to first end 26A of securing bar 26. It is not necessary that cap end 36 be disposed exactly at or near the end of securing bar 26, so long as a sufficient length of securing bar 26 extends through both securing receptacles 24 to permit panels 20A, 20B to be retained in the secured position.

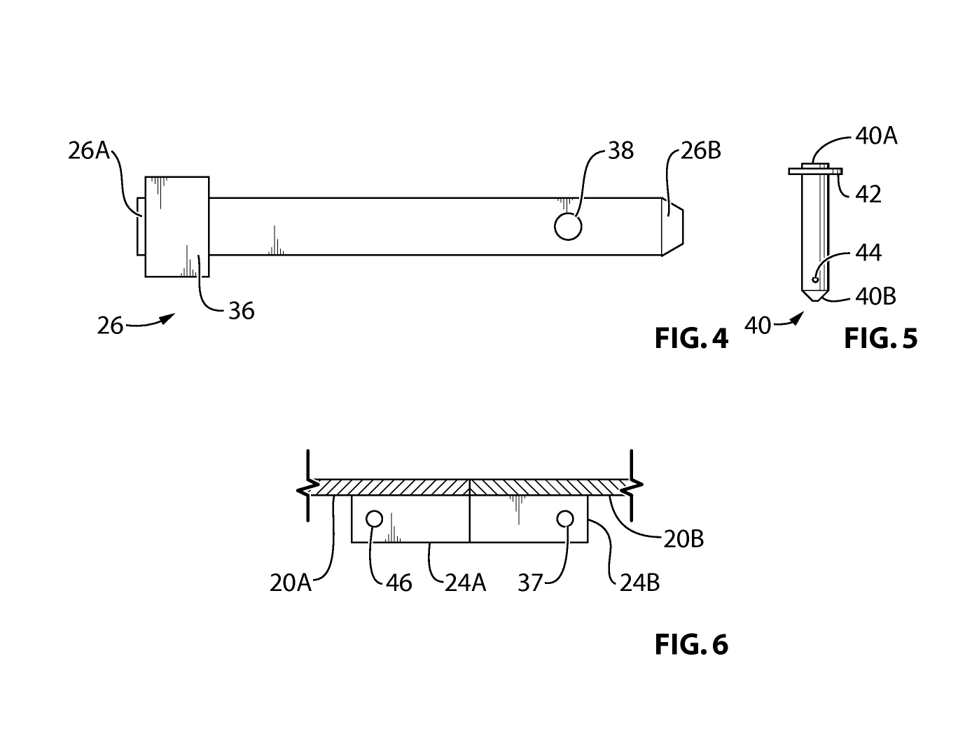

In the illustrated embodiment, second end 26B of securing bar 26 is provided with a vertically-extending aperture 38 for receiving a locking pin 40 (FIG. 5). In some embodiments, including the illustrated embodiment, second end 26B of securing bar 26 is slightly tapered to facilitate insertion of securing bar 26 into securing receptacles 24. Aperture 38 is positioned and disposed on securing bar 26 so that it aligns with a pair of vertically aligned apertures 37 (one member of which is visible in FIG. 6) formed through the top and bottom portions of locking receptacles 24B of panel 20B when securing bar 26 is placed in the secured position. In alternative embodiments, apertures 37 could be omitted and aperture 38 could be disposed on a portion of securing bar 26 that extends beyond securing receptacle 24B when securing bar 26 has been inserted through a pair of corresponding securing receptacles, so that locking pin 40 would prevent securing bar 26 from sliding back through securing receptacle 24 when the panels 20 are in the secured position.

Locking pin 40 can be secured within apertures 37 and through aperture 38 in the illustrated embodiment to lock securing bar 26 in the secured position. It will be apparent that the orientation of apertures 37 and 38 is not critical and could be varied, but a vertical orientation of apertures 37 and 38 conveniently facilitates the insertion and further securement of locking pin 40 as described below. It will also be apparent that although apertures 37 have been described as vertically aligned and aperture 38 as vertically extending, in this context it is not necessary that these structures be strictly vertical, so long as locking pin 40 can be passed through the pair of apertures 37 and through aperture 38 to lock securing bar 26 in place in the secured position.

In the illustrated embodiment, aperture 38 extends vertically through securing bar 26 and apertures 37 are in vertical alignment on securing receptacle 24B. Locking pin 40 has at a first end 40A a horizontally outwardly extending head 42 that prevents locking pin 40 from passing downwardly through apertures 37 and 38. In some embodiments, locking pin 40 is provided at its second end 40B with a locking aperture 44 for receiving a cotter pin (not shown) or other suitable securing member to further secure locking pin 40 within apertures 37 and 38 and/or to secure locking pin 40 in the travel position as described below. In some embodiments, locking aperture 44 is omitted and no securing member is provided at the second end of locking pin 40. In some embodiments, second end 40B of locking pin 40 is tapered (as shown in the illustrated embodiment), to facilitate insertion of locking pin 40 through apertures 37 and 38.

In some embodiments, two adjacent spaced apart apertures 38 are provided on securing bar 26 and two pairs of adjacent spaced apart apertures 37 are provided on securing receptacles 24B, so that two locking pins 40 can be used to hold securing bar 26 in the secured position. In such embodiments, securing receptacle 24B can be provided with two spaced apart pairs of vertically aligned apertures 37 that are positioned to be in vertical alignment with apertures 38 when panels 20 are in the secured position. Use of two locking pins 40 as aforesaid can provide additional strength or an improved safety factor to a tank constructed from a plurality of panels 20 in applications where this may be necessary or desirable.

With reference to FIG. 3, the abutting end-to-end engagement in the secured position of first panel 20A with a second panel 20B is described in greater detail. To assemble panels 20A and 20B, the panels are aligned in abutting end-to-end relationship, so that each corresponding pair of securing receptacles 24A, 24B are horizontally aligned. A securing bar 26 is passed transversely through each one of the corresponding pairs of securing receptacles 24A, 24B until cap end 36 is close to or abutting securing receptacle 24A. Locking pin 40 is inserted through apertures 37 and 38 to hold securing receptacles 24A, 24B and securing bar 26 in the secured position. In some embodiments, a cotter pin or other suitable securing member (not shown) is then inserted through locking aperture 44 of locking pin 40.

Without being bound by theory, when a plurality of panels 20 have been engaged in abutting end-to-end relationship and placed in the secured position as aforesaid to form a container in which securing bars 26 are slideably engaged and locked in place within securing receptacles 24, the outward force of the liquid or other material contained within the container against panels 20 is passed by securing receptacles 24 lengthwise along securing bar 26. Thus, much of the force applied against the walls of the tank is absorbed by cap end 36 and locking pin 40, and shear stress on securing bar 26 is lessened.

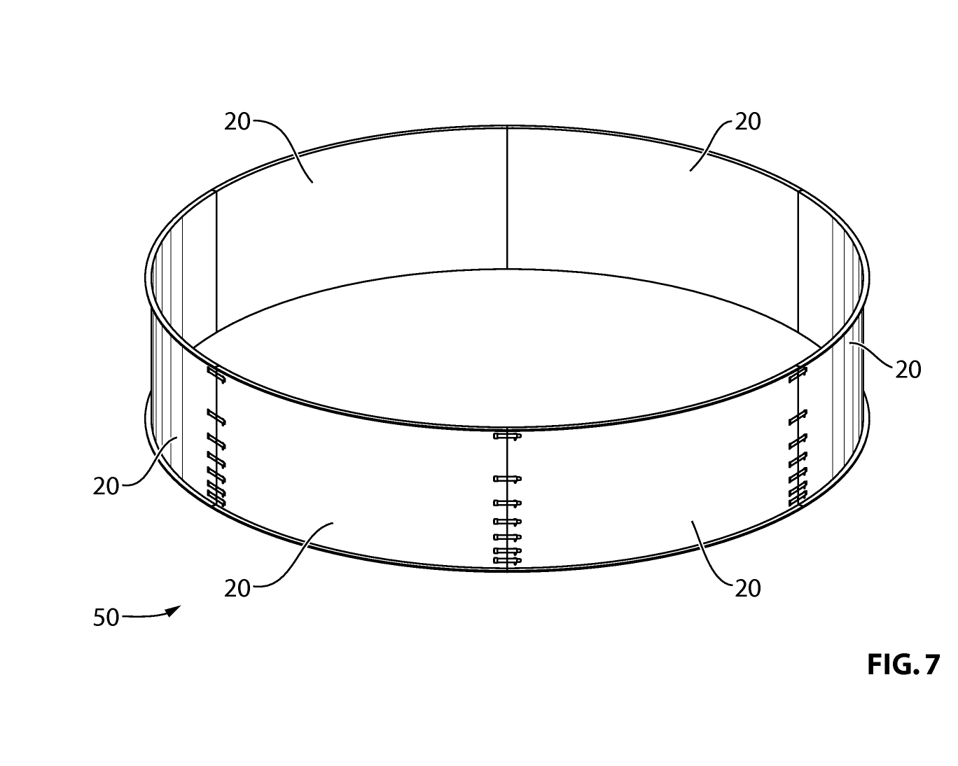

As illustrated in FIG. 7, a plurality of panels 20 can be assembled together in abutting end-to-end relationship in a similar manner as described for panels 20A and 20B to form a container 50. In some embodiments, each one of the panels 20 is curved across its length, as illustrated in FIG. 7. The number of panels required to form container 50 can be varied by varying the degree of curvature of each one of the panels 20 used to assemble container 50. For example, a container could be assembled from two panels if each panel is semi-circular in shape. In such an embodiment, securing receptacles 24 and/or securing bars 26 would need to be shaped appropriately (e.g. curved) to accommodate the higher degree of curvature in the panels. Decreasing the curvature of each one of the panels would require the use of additional panels to form a container, and would increase the diameter and useable volume of the container.

In the illustrated embodiment, securing receptacles 24 project outwardly from panel body 30, i.e. toward the outside of the container formed by assembling panels 20. Providing securing receptacles 24 on the outside of container 50 can facilitate assembly of container 50 (e.g. because assembly of panels 20 can be accomplished from the outside of container 50), and/or can assist in providing a smooth surface on the inside of container 50 (which can assist in avoiding leaks if container 50 is to be lined or used to store liquid). In alternative embodiments, the panels could be configured so that the securing receptacles project inwardly from the panel body 30 (i.e. into the interior of container 50).

If desired, for example where container 50 will be used to contain liquids, a suitable liner (not shown) can be inserted in container 50 prior to loading the material to be contained into container 50.

The size of container 50 can be varied by varying the dimensions and/or degree of curvature of panels 20 as described above. In some embodiments, container 50 is dimensioned to hold a volume of between 600,000 L and 8,000,000 L. Container 50 can be used to contain any desired material, whether liquid or solid. In some embodiments, container 50 is used to store fracturing fluids used and produced during hydraulic fracturing of oil or gas wells, or drilling fluids produced when drilling an oil well or other type of well. In other embodiments, container 50 is used for temporary potable water storage, agricultural product storage, or storage of sand or other solids, or the like.

To disassemble container 50, the contents of container 50 are removed, any liner lining container 50 is removed, locking pin 40 is removed from apertures 37, 38 after removal of any cotter pin or the like from locking aperture 44, and securing pin 26 is slid out of at least one of securing receptacles 24 (securing receptacle 24B in the illustrated embodiment). Individual panels can then be stacked or crated for storage or shipping, if desired. In some embodiments, securing pin 26 is retained on panel 20 in a travel position by insertion of locking pin through apertures 46 (FIG. 6) of the securing receptacles 24A on one of the panels as described below.

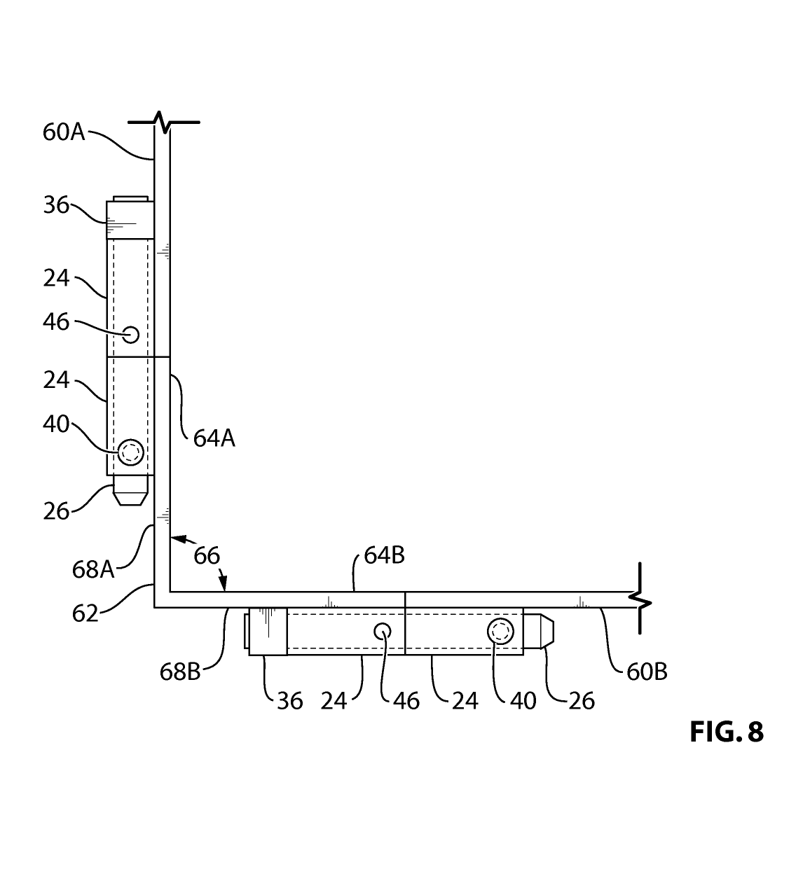

In some alternative embodiments, containers having a variety of shapes could be made by using panels having flat or relatively flat sides. For example, as illustrated in FIG. 8, a pair of flat panels 60A, 60B are connected with an angled panel 62 to form a right angle corner. By “flat panels”, it is meant that the panels 60A and 60B are generally straight (i.e. are not curved) along their length, so that the shape made by assembling a plurality of such panels has straight or generally straight edges, rather than being circular. Angled panel 62 has first and second ends 64A, 64B having a plurality of securing receptacles 24 disposed thereon. Angled panel 62 also has an angled portion 66 defined between two flat portions 60A and 60B so that corners of a container can be formed as described below.

To assemble panels 60A, 62 and 60B, panels 60A, 62 and 60B are placed in abutting end-to-end relationship. The securing receptacles 24 on first end 64A of angled panel 62 are aligned with the corresponding securing receptacles 24 on panel 60A (i.e. the securing receptacle 24 at approximately the same elevation above the base of the panel). A securing bar 26 is passed through each pair of corresponding securing receptacles 24, and is secured in place by the insertion of one or more locking pins 40 through apertures 37 and 38. In some embodiments, a cotter pin (not shown) or other suitable securing member is inserted through a locking aperture 44 in the locking pin 40.

In a similar manner, the securing receptacles 24 on second end 64B of angled panel 62 are aligned with the corresponding securing receptacles 24 on panel 60B (i.e. the securing receptacle 24 at approximately the same elevation above the base of the panel). A securing bar 26 is passed through each pair of corresponding securing receptacles 24, and is secured in place by the insertion of one or more locking pins 40 through apertures 37 and 38. In some embodiments, a cotter pin (not shown) or other suitable securing member is inserted through a locking aperture 44 in the locking pin 40.

A plurality of panels similar to panels 60A and 60B can be connected together in abutting end-to-end relationship with each other and/or angled panels 62 in like manner to form an enclosed container. In the illustrated embodiment, angled portion 66 forms a 90° angle, and thus four angled panels 62 could be used together with any desired number of panels 60A and 60B to form square or rectangular containers. Varying angles of angled portion 66 could be used to form other shapes, for example angles of 108° can be used to form a pentagonal container, angles of 135° can be used to form an octagon, and so on. It would be within the ability of one skilled in the art to select varying lengths of panels 60A and 60B and magnitudes of angled portion 62 to produce an enclosed container that is symmetrical or asymmetrical in shape with straight or generally straight edges. A plurality of flat panels 60A and 60B could be connected together in abutting end-to-end relationship in the same manner as flat panels 60A, 60B with angled panel 62 to extend the sides of the container to provide a container of the desired dimensions.

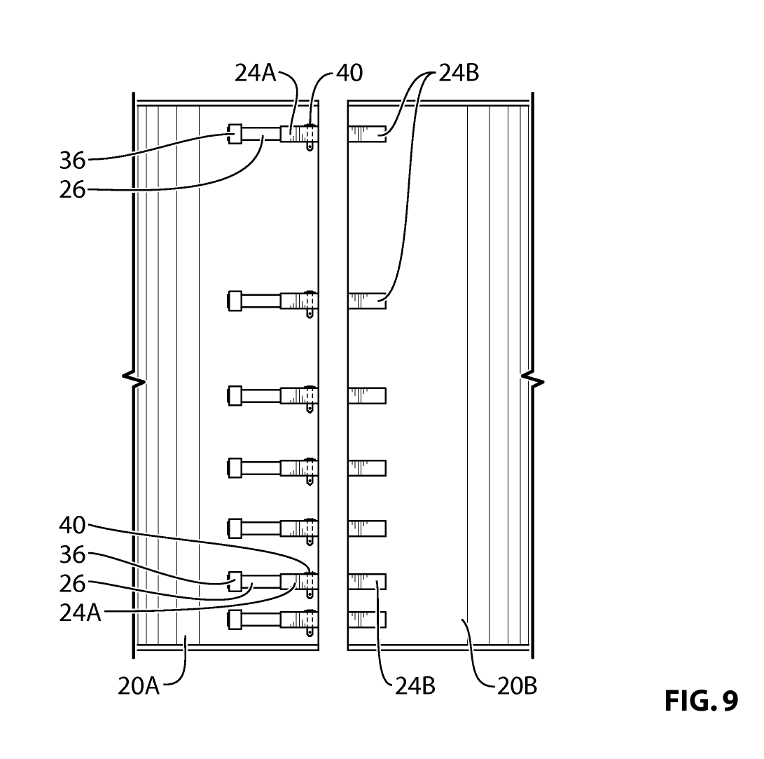

With reference to FIG. 9, in some embodiments, securing bar 26 is slideable between a securing position for securing modular panels 20 together as described above and a travel position, wherein adjacent first and second panels 20 have been released from the secured position and are free to be disassembled while securing bar 26 is retained within one member 24A of a pair of corresponding securing receptacles 24A, 24B.

FIG. 9 shows a plurality of securing bars 26 in the travel position. In the illustrated embodiment, each one of the securing bars 26 has been disengaged from securing receptacles 24B on panel 20B by removing locking pin 40 and sliding securing bar 26 out of securing receptacle 24B. Each one of the securing bars 26 is still engaged with a corresponding securing receptacle 24A on panel 20A, and locking pins 40 are engaged with a pair of vertically aligned apertures 46 (shown best in FIG. 6) formed through securing receptacles 24A and with aperture 38 in securing bar 26 to hold securing bars 26 in the travel position. In some embodiments, a cotter pin or other suitable securing member (not shown) is passed through locking aperture 44 on locking pin 40 to further retain securing bars 26 in the travel position. In some embodiments, vertically aligned apertures 46 are omitted and the ability to lock the securing bars in a travel position is not provided.

In some embodiments, two pairs of adjacent spaced apart vertically aligned apertures 46 are provided on securing receptacles 24A to accommodate engagement of two locking pins 40 in spaced apart side-by-side relation. This may be desirable, for example, in embodiments in which securing bar 26 includes two adjacent spaced apart apertures 38 for receiving two locking pins 40.

In some embodiments, panel 20 is symmetrical about a central vertical axis; that is, sides 20A and 20B of panel 20, including the placement of apertures 46 relative to apertures 38, are mirror images of one another.

Use of the travel position as aforesaid can facilitate the assembly and disassembly of a container 50 formed from a plurality of panels 20, since securing bars 26 do not need to be separately transported, and are conveniently positioned for assembling panels 20 into the secured position when container 50 needs to be set up. Locking pins 40 can be removed from apertures 38 and 46, the securing bar 26 can be slid through the securing receptacles 24 to the secured position, and locking pins 40 can be passed through apertures 37, 38 as described above to secure panels 20 in the secured position.

In some embodiments, use of the travel position enhances the safety of persons using panels 20. All components of panel 20 required for complete assembly of a container 50 are retained together on panel 20 as a single unit so that no additional components need to be installed on panel 20 from a ladder. The components of panel 20 required for complete assembly of container 50 are also conveniently retained together in the correct position to facilitate assembly of container 50. The components of panel 20 can also be easily transported, and the risk that components of panel 20 such as securing bar 26 will be lost during transport is reduced.

While a number of exemplary aspects and embodiments have been discussed above, those of skill in the art will recognize certain modifications, permutations, additions and sub-combinations thereof. For example,
although a preferred embodiment of a panel suitable for use to form a container for the storage of large volumes of liquid has been described in detail herein, other forms of panel constructed of other types of material could be made employing the same fastening system to store lighter materials or smaller quantities;
the relative orientation of cap end 36 and aperture 38 on securing bar 26 could be reversed;
both ends of securing bar 26 could be provided with apertures for receiving locking pins 40 instead of one end of securing bar 26 being provided with a cap end 36 as illustrated. For example, in embodiments including apertures 46 for retaining the securing bars 26 in the travel position, apertures 46 could serve together with locking pins 40 and a second aperture through securing bar 26 as a locking mechanism to retain panels 20 in the secured position; and/or
any suitable clipping or clamping mechanism could be used to retain securing bars 26 in the travel position instead of inserting locking pins 40 through apertures 38 and 46.
   It is therefore intended that the following appended claims and claims hereafter introduced should not be limited to the preferred embodiments described above, but should be given the broadest interpretation consistent with the specification as a whole.

What is claimed is:

1. A modular panel for use in forming a container, the panel having first and second ends, the panel comprising:
a plurality of securing receptacles on the first end of the panel, and
a plurality of securing receptacles on the second end of the panel,
each one of the plurality of securing receptacles on the first end of the panel being positioned at approximately the same elevation relative to a base of the panel as a corresponding one of the securing receptacles on the second end of the panel to provide a pair of corresponding securing receptacles,
each pair of corresponding securing receptacles being dimensioned to receive a securing bar therein so that the securing bar can be retained within the securing receptacles to hold the panels in a secured position when the panels are engaged in abutting end-to-end relationship.

2. A modular panel as defined in claim 1, wherein the securing bar comprises a locking mechanism at its first end and a locking mechanism at its second end, and wherein the securing bar is slideably received within the securing receptacles.

3. A modular panel as defined in claim 2, wherein the locking mechanism at the first end of the securing member comprises an end cap, and wherein the locking mechanism at the second end of the securing member comprises an aperture sized and positioned to receive a locking pin.

4. A modular panel as defined in claim 2, wherein the locking mechanisms at both the first and second ends of the securing member comprise apertures sized and positioned to receive a locking pin.

5. A modular panel as defined in claim 3, wherein the plurality of securing receptacles on the second end of the panel comprise a pair of vertically aligned apertures for receiving the locking pin when the panel is engaged in the secured position with a second panel in abutting end-to-end relationship.

6. A modular panel as defined in claim 5, wherein the plurality of securing receptacles on the first end of the panel comprise a pair of vertically aligned apertures for receiving the locking pin when the securing member is secured in a travel position to only the securing receptacle on the first end of the panel.

7. A panel assembly comprising two modular panels as defined in claim 1 in abutting end-to-end engagement, with the securing receptacles on the first end of a first one of the panels being positioned adjacent the securing receptacles on the second end of a second one of the panels, the panels being retained in the secured position by at least one securing bar locked within at least one of the pairs of corresponding securing receptacles.

8. A panel assembly as defined in claim 7, wherein the securing bar is slidably received within the securing receptacles.

9. A panel assembly as defined in claim 8, wherein the securing bar comprises a cap end at a first end of the securing bar and a locking aperture for receiving a locking pin at a second end of the securing bar, the cap end of the securing bar being in proximity to an outside edge of one of the securing receptacles on the first one of the panels, and the second end of the securing bar being restrained from relative motion with respect to the securing receptacles by engagement of a locking pin with the locking aperture and a pair of vertically aligned apertures on the corresponding one of the securing receptacles on the second end of the second one of the panels.

10. A fastening system for securing two modular panels in abutting end-to-end relationship, the fastening system comprising:
a plurality of pairs of corresponding securing receptacles, a first member of each pair of corresponding securing receptacles being provided on one end of a first one of the modular panels and a second member of each pair of corresponding securing receptacles being provided on one end of a second one of the modular panels at approximately the same elevation relative to a base of the panels as the first member of the pair of corresponding securing receptacles; and
a plurality of securing bars, each one of the securing bars being slideably engageable within one of the pairs of corresponding securing receptacles, each one of the securing bars having a locking mechanism to prevent movement of the securing bar relative to the pair of corresponding securing receptacles when the panels are in a secured configuration.

11. A fastening system as defined in claim 10, wherein the securing bar comprises a locking mechanism at or near each of its ends.

12. A fastening system as defined in claim 11, wherein the locking mechanism at a first end of at least one of the securing bars comprises a locking aperture for receiving a locking member therein.

13. A fastening system as defined in claim 12, wherein the locking mechanism at a second end of at least one of the securing bars comprises a cap.

14. A fastening system as defined in claim 12, wherein the locking aperture for receiving the locking member therein extends vertically through the securing bar, and at least one member of each one of the pairs of corresponding securing receptacles comprises a pair of vertically aligned apertures therethrough, the vertically aligned apertures being positioned and dimensioned to align with the locking aperture when the panels are in the secured configuration.

15. A method of assembling a container formed from two or more modular panels, the method comprising:
aligning first and second modular panels in abutting end-to-end relationship, so that each one of a plurality of securing receptacles on one end of the first modular panel is aligned with a corresponding one of a plurality of securing receptacles on one end of the second modular panel to provide a pair of corresponding securing apertures;
inserting a securing bar through at least two of the pairs of corresponding securing apertures; and
locking the securing bar against movement relative to the securing receptacles.

16. A method as defined in claim 15, wherein locking the securing bar against movement relative to the securing receptacles comprises:
securing a first end of the securing bar against movement relative to the securing receptacles; and
securing a second end of the securing bar against movement relative to the securing receptacles.

17. A method as defined in claim 16, wherein securing the first end of the securing bar against movement relative to the securing receptacles comprises sliding the securing bar into the pair of corresponding securing receptacles until a cap at a first end of the securing bar contacts an outside edge of the securing receptacle on the end of the first modular panel.

18. A method as defined in claim 17, wherein securing the second end of the securing bar against movement relative to the securing receptacles comprises passing a locking pin through a locking aperture in a second end of the securing bar and through a pair of vertically aligned apertures in the securing receptacle on the end of the second modular panel.

19. A method as defined in claim 16, wherein inserting the securing bar through the at least two of the pairs of corresponding securing apertures comprises first removing a locking pin retaining the securing bar in a travel position engaged with only the securing receptacle on one end of the first modular panel, and then sliding the securing bar into the pair of corresponding securing receptacles.

20. A panel assembly comprising two or more panels secured together with a fastening assembly as defined by claim 10.

21. A container formed by the engagement of a plurality of panels as defined by claim 1 in abutting end-to end relationship.

22. A tank for storing fracturing fluids used and produced during hydraulic fracturing of oil or gas wells comprising a modular container as defined in claim 21.
